(19) United States
(12) Patent Application Publication
(10) Pub. No.: US 2004/0250400 A1
(43) Pub. Date: Dec. 16, 2004

(54) Deck pin insertion and extraction tool for robotic sample pipette instruments

(76) Inventors: Francine Caproon, Ocala, FL (US); Dana C. Caproon, Ocala, FL (US); Stephen R. Grissom, Mount Dora, FL (US)

Correspondence Address: EDWARD M. LIVINGSTON, ESQ., 628 ELLEN DR., P.O. BOX 1599, WINTER PARK, FL, 32790, US

(21) Appl. No.: 10/461,785

(22) Filed: Jun. 13, 2003

(51) Int. Cl. B23P 19/04

(52) U.S. Cl. 29/426.5; 29/253; 29/451; 29/278

(57) ABSTRACT

A tool for inserting and extracting pins into and from slots in a planar surface, such as deck pins in a robotic sample pipette (RSP) instruments. The tool (5) uses common or separate channels on the same or separate tools to slide over the deck pins (1), thereby compressing the flexible legs (2) of the deck pins (1) together. An upward movement on the handle (7) of the tool enables the deck pins (1) to be extracted. The insertion channel (22) contains a roof portion (16) for pressing downward on the deck pins (1).

### BACKGROUND OF THE INVENTION

This invention relates to hand tools for inserting and extracting pins into and from a planar surface, and more particularly, a tool for removing and replacing deck pins from slots in decks of robotic sample pipette (RSP) instruments.

An RSP is a medical instrument that is used to take blood from vials or test tubes and insert it into other vials for testing purposes. An RSP is commonly used in most laboratories for testing donated blood and in the pharmaceutical industry for testing drugs. Deck pins, which have flexible legs, are inserted into slots to hold the test tubes in the deck of the RSP inserted to hold in the flatbed or deck of the RSP. When test tubes are moved for testing by the machine, the deck pins, which are made of plastic, often become damaged and break, requiring replacement. Such damage is hastened by the fact that the decks of RSP machine are required to be washed with bleach for contamination reasons, which further deteriorates the plastic deck pins resulting in even more breakage.

Normally, the deck pins are replaced by hand, which can cause injury to fingers and breakage to fingernails. Sometimes a claw hammer is used, but that can cause damage to a RSP. Further, once a deck pin is removed, it must be replaced with another deck pin, which again requires that someone use his or her fingers to squeeze the legs and push down on the deck pin. As the deck of an RSP may contain as few as 120 deck pins and more, the deck pin replacement process is very tedious and time consuming.

There is no known insertion and removal tool for deck pins. The prior patented art includes the following patented tools:

| Patent No. | | |
|---|---|---|
| (U.S. unless stated otherwise) | Inventor | Issue Date |
| 6,324,741 | Brown | Dec. 4, 2001 |
| FR 2,807,357 | Chapel, et al. | Oct. 12, 2001 |
| GB 2,137,919 | Lee | Oct. 17, 1984 |
| 5,585,070 | Lessard, et al. | Dec. 17, 1996 |
| 5,611,519 | Garcia | Mar. 18, 1997 |
| 6,400,152 | Bagley | Jun. 25, 2002 |
| 2,533,112 | Hayden | Dec. 5, 1950 |
| 6,095,578 | Roth, et al. | Aug. 1, 2000 |

Although some of the above patents disclose fastener remover tools, none has the same structure as the present invention which allows it to be used to insert and extract deck pins from an RSP.

### SUMMARY OF THE INVENTION

The primary object of the present invention is to provide a tool for inserting deck pins into an RSP.

Another object of the present invention is to provide a tool for extracting deck pins from an RSP.

A further object of the present invention is to provide such a tool that reduces damage to deck pins during insertion and extraction.

An even further object of the present invention is to provide such a tool that also reduces injury to workers during deck pin insertion and extraction.

An additional object of the present invention is to provide such a tool that also reduces the time necessary for insertion and extraction of the deck pins.

Another object of the present invention is to provide such a tool that is easy to use.

An ancillary object of the present invention is to provide such a tool that reduces costs due to savings in labor and damage to deck pins.

The present invention fulfills the above and other objects by providing a tool which can be used for either or both the insertion and extraction of deck pins in a RSP deck. Each pin has a top with slanted sides and at least one (1) set of flexible legs which extend vertically downward from a bottom of the deck pin for inserting holes in the deck of the RSP surface. Each leg has at least one (1) holding barb at the bottom for holding the legs in each hole. Each tool has a handle section for grasping with one (1) hand and an insertion and/or removal section having a channel sized and shaped for sliding over a top section of a deck pin. Each channel has downwardly and inwardly slanted sides to squeeze the flexible legs of the deck pin inward so the deck pin can be either inserted or extracted from a pin hole in a deck without interference from the holding barbs or inserted therein. The insertion channel has a roof extending over the deck pin so the deck pin can be pushed downward after insertion into a pin hole in a deck so that the barbs on each leg can lock the deck pin in the hole. One (1) embodiment of the tool shares a common channel for both insertion and extraction while another embodiment have separate insertion and removal sections.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side view of a deck pin typically used in a robotic sample pipette (RSP);

FIG. 2 is an end view of the deck pin of FIG. 1;

FIG. 3 is a side view of an insertion/extraction tool of the present invention;

FIG. 4 is a top plan view of an insertion/extraction tool of the present invention;

FIG. 5 is a front end view of insertion/extraction tool of the present invention;

FIG. 6 is a side plan view of the tool being used to extract a deck pin from an RSP;

FIG. 7 is a side plan view of the tool being used to insert a deck pin into a RSP;

FIG. 8 is a side view of a second embodiment of an insertion/extraction tool;

FIG. 9 is a bottom view of the tool in FIG. 8;

FIG. 10 is a front end view of the tool of FIG. 8; and

FIG. 11 is an aft end view of the tool of FIG. 8.

### DESCRIPTION OF THE PREFERRED EMBODIMENTS

For purposes of describing the preferred embodiment, the terminology used in reference to the numbered components in the drawings is as follows:

| | |
|---|---|
| 1. | Deck pin |
| 2. | Legs of deck pin |
| 3. | Top of deck pin |
| 4. | Locking barbs |
| 5. | Tool, generally |
| 6. | Extraction prong |
| 7. | Handle |
| 8. | Insertion section |
| 9. | Top of insertion section |
| 10. | Insertion channel |
| 11. | Channel sides |
| 12. | Bottom surface |
| 13. | Extraction channel |
| 14. | Deck |
| 15. | Slot in deck |
| 16. | Roof |
| 17. | Second tool embodiment |
| 18. | Handle |
| 19. | Front end |
| 20. | Aft end |
| 21. | Bottom surface |
| 22. | Insertion channel |
| 23. | Extraction channel |
| 24. | Roof of extraction channel |
| 25. | Sides of deck pin |
| 26. | Roof of insertion channel |

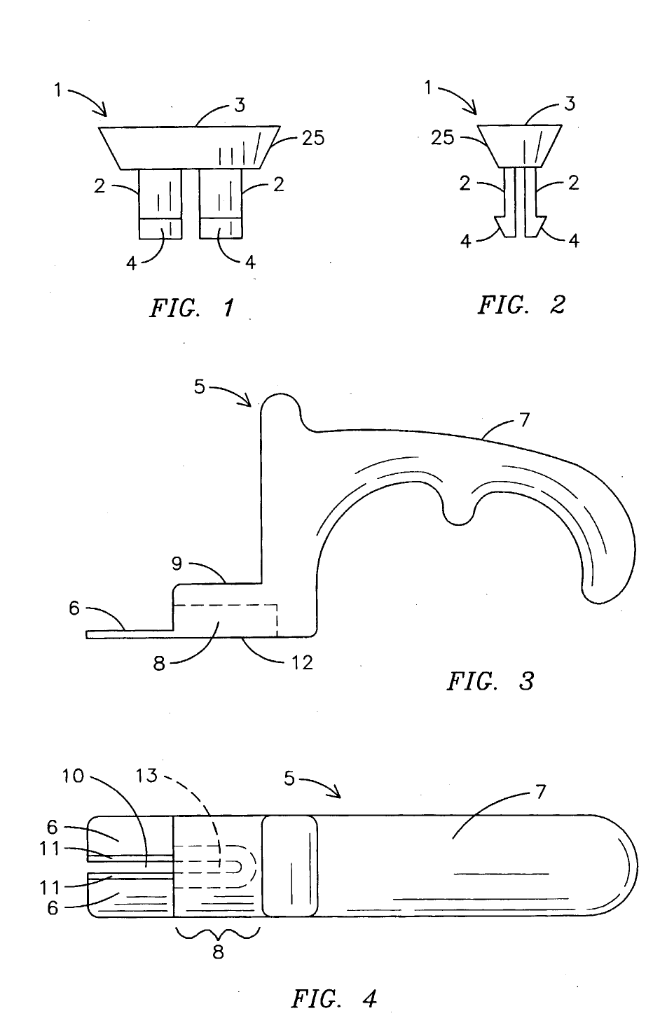

Reference is made to the drawings to discuss the preferred embodiments of the present invention. In FIG. 1, a typical deck pin 1 used in conjunction with an RSP is shown to have a top section in FIG. 1, have inwardly slanted sides 25 with at least one (1) set of flexible legs 2 extending from a bottom thereof. The bottom of each leg 2 contains a barb 4 designed to lock the deck pin in place when it is inserted into a hole of an RSP deck.

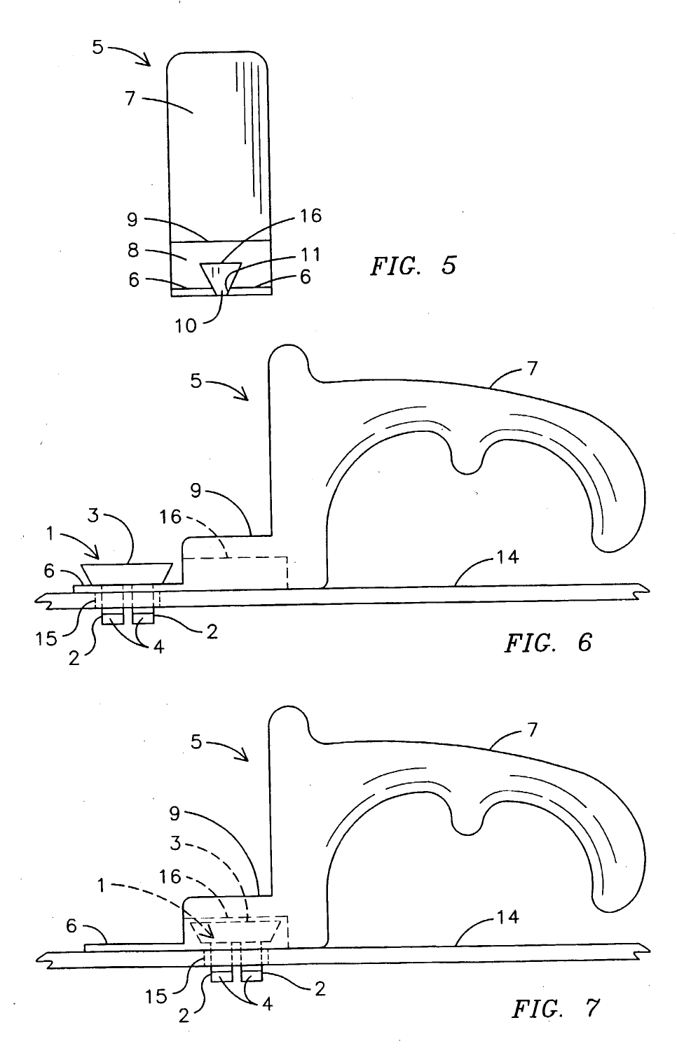

FIGS. 3, 4, and 5 show one (1) embodiment of the insertion/extraction tool of the present invention, said tool having a handle 7 at a proximal end and a insertion/extraction section (8 and 9, respectively) at a distal end. A channel 10 is sized and shaped to slide over an end of a deck pin. The channel 10 has downwardly and inwardly slanted walls 11 designed to compress or squeeze inward on the flexible legs 2 of a deck pin so that the barbs 4 release the legs from a bottom side of an RSP deck. The extraction section of the tool 5 uses two (2) extraction prongs 6. The insertion section 8 has a top section 9 which has an interior roof 16 for use in pressing down on a top surface 3 of the deck pin 1 during the insertion process.

The deck pin extraction process is illustrated in FIG. 6 using the tool 5. A deck pin 1 is extracted by using the handle 7 to slide the extraction prong 6 over the deck pin 1 so that the deck pin 1 is in the channel 10 of the prong 6. Then, an upward movement on the handle 7 will cause the deck pin 1 to be released from the RSP deck 14.

The insertion process is illustrated in FIG. 7, in which the handle 7 is used to place the tool 5 over the deck pin 1 until the deck pin rests in the insertion channel 10 of the tool 5. Then, the legs 2 of the deck pin are inserted into a slot 15 of an RSP deck 14. Then, downward pressure is applied to the top surface of the deck pin 3 using the roof 16 until the barbs 4 secure the deck pin 1 on of the deck 14.

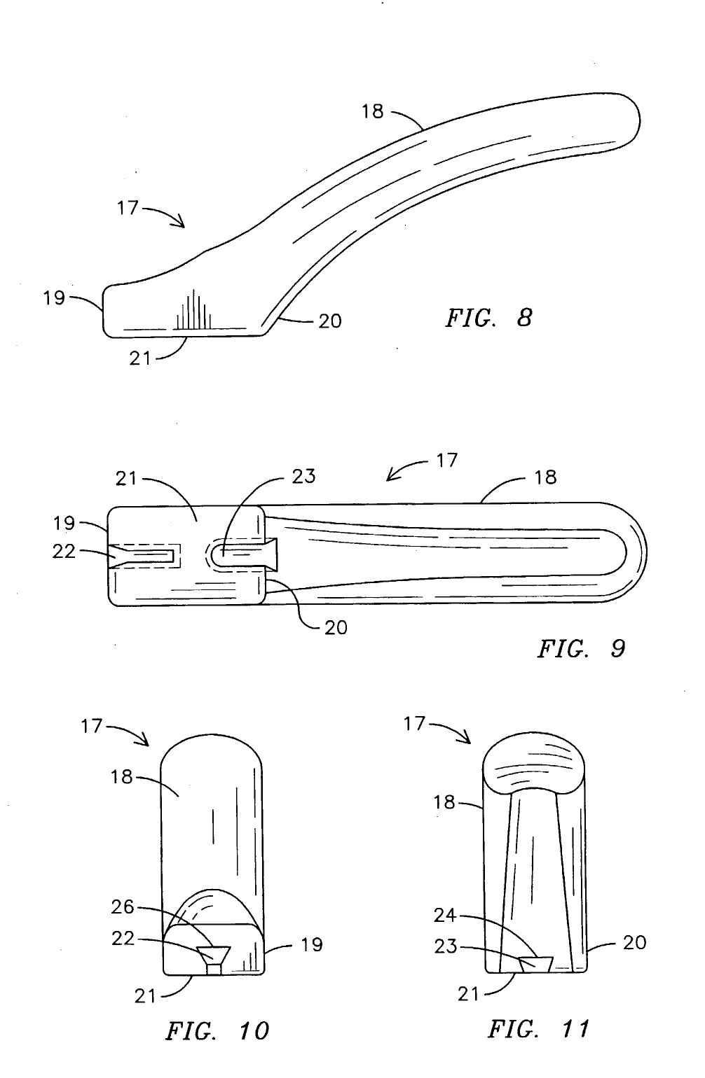

Although the embodiment of the insertion/extraction tool 5 illustrated in FIGS. 3-7 shares a common channel 10, the insertion and extraction sections could use separate channels as illustrated in the embodiment of FIGS. 8-11 discussed hereafter or could even be placed on separate tools altogether as is also contemplated by this invention. The tool 17 illustrated in FIGS. 8-11 has a handle 18 and separates insertion and extraction sections having a front end 19, an aft end 20 on a bottom surface 21. The bottom surface 21 contains separate channels for extraction and insertion, an insertion channel 22 in the front end 19 and an extraction channel 23 on an aft end 20. The insertion channel 22 has a roof 26, which is used to impart a downward force on a top surface of the deck pin during the insertion process. The extraction channel 23 has a roof 24 lower than a roof 26 of the insertion channel 22 so that it slides over a deck pin in such a matter that the deck pin is forced upward and out of the deck pin slot 15.

The tool may be made of any rigid material having sufficient strength so that the channel or channels used for inserting and extracting the deck pin are sufficiently strong to compress the legs of the deck pin during the insertion process. The material may include, without limitation, nylon, plastic and wood.

Although a few embodiments of a tool for inserting and extracting deck pins in an RSP instrument deck have been illustrated and described, any single or multiple tool which has one (1) or more channels for either inserting or extracting pins into and from slots in a planar surface wherein at least the insertion channel has a roof for pressing downward on the pins is covered by this invention.

Having thus described our invention, we claim:

1. A tool for inserting and extracting pins into and from a deck, each pin having a top section with slanted sides and at least two (2) flexible legs extending down from a bottom surface, each leg having a holding barb at the bottom thereof said tool comprising:
a handle for grasping the tool with one (1) hand; and
an extraction section having an extraction channel sized and shaped for sliding over the top section of the pin, said channel having downwardly and inwardly slanted sides to compress the legs of the pin inward to release the barbs from under a bottom surface of a deck so the pin can be extracted.

2. The tool of claim 1 further comprising:
an insertion section sharing a channel with the extraction section, said insertion section having a roof for pressing downward on top of the pin until the barbs of the legs of the pin are below the bottom surface of the deck to secure the pins in holes in the deck.

3. The tool of claim 1 further comprising:
an insertion section having a separate insertion channel sized and shaped for holding a top section of a pin, the channel having sides which narrow downwardly so the sides compress slightly inward to the legs of a pin, said channel further having a roof for pressing downward on top of the pin until the barbs of the pin are below the bottom surface of the deck.

4. The tool of claim 1 wherein the extraction section is in a forward end of the tool and further comprises two (2) prongs, one (1) on each side of the extraction channel.

5. The tool of claim 2 wherein the insertion section is contained in an aft portion of the channel as the extraction section.

6. The tool of claim 3 wherein the insertion channel is on the bottom of a forward end of the tool and the extraction channel is on an aft end of the tool.

7. A tool for inserting and extracting pins into and from a deck, each pin having a top section with slanted sides and at least two (2) flexible legs extending downward from a bottom surface, each leg having a holding barb at the bottom thereof, said tool comprising:
a handle for grasping the tool with one (1) hand; and
an insertion section having an insertion channel sized and shaped for sliding over the top section of the pin, said channel having a downwardly and inwardly slanted sides to press the legs of the pin inward and having a roof for pressing downward on top of the pin until the barbs on the legs are below the bottom surface of the deck to secure the pins in the holes of the deck.

8. The tool of claim 7 further comprising:
an extraction section having an extraction channel sized and shaped for sliding over the top section of the pin, said channel having downwardly and inwardly slanted sides to compress the legs of the pin inward to release the barbs from under the bottom surface of the deck so the pin can be extracted.

9. The tool of claim 8 further comprising:
an insertion section having a separate insertion channel sized and shaped for holding a top section of a pin, the channel having sides which narrow downwardly so the sides compress inward the legs of a pin, said channel further having a roof for pressing downward on top of the pin until the barbs of the pin are below the bottom surface of the deck.

10. The tool of claim 8 wherein the extraction section is in a forward end of the tube and further comprises two (2) prongs, one (1) on each side of the extraction channel.

11. The tool of claim 8 wherein the insertion section is contained in an aft portion of the same channel as the extraction section.

12. The tool of claim 9 wherein the insertion channel is on the bottom of a forward end of the tool and the extraction channel is on an aft end of the tool.

13. A method for extracting pins from slots in a planar surface, each deck pin having a top section with slanted sides and at least two flexible legs extending down from a bottom surface, each leg having a holding barb at the bottom thereof, said tool comprising a handle for grasping a tool with one (1) hand and an extraction section having an extraction channel sized and shaped for sliding over the top section of the pin, said channel having downwardly and inwardly slanted sides to compress the legs of the pin inward to release the barbs from under a bottom surface of the planar surface so the pin can be extracted, said method comprising the steps of:
pushing the extraction channel of the tool over the planar surface so the pin slides into the channel of the tool; and
pulling upward on the handle until the pin is lifted from the slot in the deck.

14. A method of inserting a pin into slots in a planar surface using a tool as described in claim 7 comprising the steps of:
sliding the tool over the pin so the pin slides into the insertion channel; and
pushing downward on the handle so the roof of the insertion channel pushes downward until the legs of the pin are secured below the planar surface.
